(19) United States
(12) Patent Application Publication
(10) Pub. No.: US 2025/0059314 A1
(43) Pub. Date: Feb. 20, 2025

(54) ONE-COMPONENT POLYURETHANE SPRAY FOAM COMPOSITIONS AND DISPENSERS THEREOF

(71) Applicant: DAP Global Inc., Baltimore, MD (US)

(72) Inventors: Nicholas R. YEATES, Fenton, MO (US); Jay ZHANG, Fenton, MO (US); Nicholas LANGE, Fenton, MO (US); Kevin CORCORAN, Fenton, MO (US)

(21) Appl. No.: 18/719,739

(22) PCT Filed: Dec. 14, 2022
(86) PCT No.: PCT/US22/81531

§ 371 Date: Jun. 13, 2024

Related U.S. Application Data
(60) Provisional application No. 63/289,408, filed on Dec. 14, 2021.

(51) Int. Cl. C08G 18/50; C08G 18/10; C08G 18/20; C08K 5/02; C08K 5/521

(52) U.S. Cl. CPC C08G 18/5003; C08G 18/10; C08G 18/2081; C08K 5/02; C08K 5/521; C08G 2150/60

(57) ABSTRACT

Described herein are fire-resistant one-component polyurethane spray foam compositions. Also described herein are methods of making and using fire-resistant one-component polyurethane spray foam compositions. Also described herein are dispensers for dispensing the fire-resistant one-component polyurethane spray foam compositions. Compositions and methods in accordance with the present disclosure are useful in a wide variety of applications, and particularly useful in meeting building codes for construction applications.

### RELATED APPLICATIONS

This application claims priority to U.S. Provisional Application Ser. No. 63/289,408, filed on Dec. 14, 2021, the contents of which are hereby incorporated by reference in their entirety.

### FIELD OF DISCLOSURE

This disclosure is directed to fire resistant one-component polyurethane spray foam compositions. This disclosure is also directed to methods of making and using fire resistant one-component polyurethane spray foam compositions. This disclosure is also directed to dispensers for dispensing the fire resistant one-component polyurethane spray foam compositions. Compositions and methods in accordance with the present disclosure are useful in a wide variety of applications, and particularly useful in construction applications.

### BACKGROUND

Two-component foam compositions, also known as 2K formulations, are commonly used in a variety of applications, including spraying in construction applications. Two-component foam compositions are generally packaged with the two components maintained in two separate containers. They must be applied with suitable equipment or mechanisms for maintaining a proper spray ratio, typically about 1:1. Many factors, such as temperature, pressure, and spray gun functions, can cause poor spray performance and thereby result in a poor foam quality due to improper spray ratio and mixing.

One-component foam compositions, also known as 1K formulations or OCF, are also widely used in a variety of applications, including construction applications. Conventional one-component polyurethane foam formulations typically include polyols (polyester/or polyether polyol with functionality of about 2 to 3), a catalyst (typically DMDEE (dimorpholine diethyl ether)), a foam stabilizer/surfactant, a flame retardant (typically TCPP (Tris (chloroisopropyl) phosphate) or TDCPP (Tris(1,3-dichloro-2-propyl) phosphate)) and/or Chlorinated Paraffins, polymeric MDI, and a propellant/blowing agent. In aerosol can formulations (in sizes of 30.5 oz or less), flammable propellants are typically used (e.g. a blend of propane, n-butane, i-butane, dimethyl ether, and/or hydrofluorocarbon-152a (HFC-152a)). In canister formulations (in typical sizes of 10, 16, or 23 lbs.), non-flammable propellants are typically used. These non-flammable propellants can be one or more of HFC-134a (1,1,1,2-Tetrafluoroethane), HFC-245fa (1,1,1,3,3-Pentafluoropropane), HFO-1234ze (1,3,3,3-Tetrafluoropropene), HFO-1233zd (1-Chloro-3,3,3-trifluoropropene), HFO-1336mzz-Z (Cis-1,1,1,4,4,4-Hexafluoro-2-butene), HFO-1336mzz-E (Trans-1,1,1,4,4,4-Hexafluoro-2-butene), etc.). Non-flammable propellants may also include nitrogen gas or other such suitable gases. Regardless, conventional one-component polyurethane foam formulations are only capable of meeting building codes requirements for being bead-applied. Building Codes commonly require at least Class II when tested per ASTM E 84, UL-723 or ULC-S-102. Yet Class I rated foam can be used in wider range of applications for residential or commercial buildings, and is therefore more desirable.

One-component polyurethane foam formulations are commonly limited in construction applications to bead applications as sealants or adhesives in ¼″ to 2″ size beads. One-component polyurethane foam formulations may pass the ASTM E 84 Class I or Class II fire test if applied in only two or three foam beads, with diameter of ¼″ to 1″ (typically ¾″) on 24′ wide test boards. But these foam formulations will not pass the ASTM E 84 Class I or II fire test if the foam fully covers the 24″-wide test boards. Thus, conventional one-component polyurethane foam formulations have been limited by their fire resistance performance and have not been used in spray applications.

Yet one-component foam compositions that are configured for spraying in broadcast fashion are desirable in the art. Such formulations must meet certain fire resistance performance to be usable.

One-component foam compositions configured for spraying have been attempted previously. For example, U.S. Pat. No. 10,815,353 provides a sprayable one-component foam formulation. However, the foam product sprayed from such a formulation would not meet the minimal requirement of building codes, including neither Class I nor Class II.

The present disclosure provides one-component foam compositions that are fire resistant and configured for spraying, and particularly broadcast spraying. The compositions of the present disclosure are useful in a wide variety of applications, and particularly useful in construction applications such as filling wall cavities or insulating rim joists or band joists.

### BRIEF DESCRIPTION OF THE DISCLOSURE

In one aspect, provided herein is a one-component polyurethane spray foam composition comprising: a polyol; a compound containing one or more isocyanate functional groups; a propellant; a flame retardant; optionally a surfactant; and optionally a catalyst.

In another aspect, provided herein is a method of making a one-component polyurethane spray foam composition comprising: a polyol; a compound containing one or more isocyanate functional groups; a propellant; a flame retardant; optionally a surfactant; and optionally a catalyst. The method comprises forming a mixture comprising: a polyol; a compound containing one or more isocyanate functional groups; a propellant; a flame retardant; optionally a surfactant; and optionally a catalyst.

In yet another aspect, provided herein is a method of using a one-component polyurethane spray foam composition comprising: a polyol; a compound containing one or more isocyanate functional groups; a propellant; a flame retardant; optionally a surfactant; and optionally a catalyst. The method comprises applying the one-component polyurethane spray foam composition to an application site.

In still another aspect, provided herein is a dispenser comprising: a pressurized container comprising: a reservoir comprising a one-component polyurethane spray foam composition; and a valve assembly; and a mechanical applicator comprising: a valve connection fluidically connected to the valve assembly of the pressurized container; an outlet nozzle fluidically connected to the valve connection; and a fan spray outlet comprising a cat-eye-shaped aperture, wherein the fan spray outlet is fluidically connected to the outlet nozzle.

### BRIEF DESCRIPTION OF THE DRAWINGS

FIG. 1 is an exemplary embodiment of a front view of a cat-eye shaped aperture in accordance with the present disclosure.

FIG. 2 is an exemplary embodiment of a rear view of an X-shaped washer in accordance with the present disclosure.

FIG. 3A is an exemplary embodiment of a cross-sectional view of a nozzle assembly configured to be used with an aerosol can in accordance with the present disclosure.

FIG. 3B is an exemplary embodiment of a side view of a nozzle assembly configured to be used with an aerosol can in accordance with the present disclosure.

FIG. 3C is an exemplary embodiment of a side view of a nozzle assembly configured to be used with an aerosol can in accordance with the present disclosure.

FIG. 3D is an exemplary embodiment of a cross-sectional view of a nozzle assembly configured to be used with an aerosol can in accordance with the present disclosure.

FIG. 4A is an exemplary embodiment of a side view of a nozzle assembly connected to an aerosol can in accordance with the present disclosure.

FIG. 4B is an exemplary embodiment of a perspective view of a nozzle assembly connected to an aerosol can in accordance with the present disclosure.

FIG. 4C is an exemplary embodiment of a perspective view of a nozzle assembly connected to the side of an aerosol can in accordance with the present disclosure.

FIG. 5A is an exemplary embodiment of a perspective view of a nozzle assembly configured to be used with a canister in accordance with the present disclosure.

FIG. 5B is an exemplary embodiment of a side view of a nozzle configured to be used with a canister in accordance with the present disclosure.

FIG. 5C is an exemplary embodiment of a cross-sectional view of a nozzle configured to be used with a canister in accordance with the present disclosure.

FIG. 6 is an exemplary embodiment of a side view of a nozzle assembly configured to be connected to a canister in accordance with the present disclosure.

FIG. 7 is an exemplary embodiment of a perspective view of a nozzle assembly connected to a canister in accordance with the present disclosure.

FIG. 8A is an exemplary embodiment of a cross-sectional view of a nozzle assembly configured to be used with an aerosol can in accordance with the present disclosure.

FIG. 8B is an exemplary embodiment of a side view of a nozzle assembly configured to be used with an aerosol can in accordance with the present disclosure.

FIG. 8C is an exemplary embodiment of a side view of a nozzle assembly configured to be used with an aerosol can in accordance with the present disclosure.

FIG. 8D is an exemplary embodiment of a cross-sectional view of a nozzle assembly configured to be used with an aerosol can in accordance with the present disclosure.

FIG. 9A is an exemplary embodiment of a cross-sectional view of a nozzle assembly configured to be used with a canister in accordance with the present disclosure.

FIG. 9B is an exemplary embodiment of a side view of a nozzle configured to be used with a canister in accordance with the present disclosure.

FIG. 9C is an exemplary embodiment of a cross-sectional view of a nozzle configured to be used with a canister in accordance with the present disclosure.

FIG. 10 is an exemplary embodiment of a side view of a nozzle assembly connected to an aerosol can in accordance with the present disclosure.

FIG. 11A is an exemplary embodiment of a cross-sectional view of a nozzle assembly configured to be used with a canister in accordance with the present disclosure.

FIG. 11B is an exemplary embodiment of a side view of a nozzle assembly configured to be used with a canister in accordance with the present disclosure.

### DETAILED DESCRIPTION OF THE DISCLOSURE

One-component polyurethane foam compositions in accordance with the present disclosure are fire resistant and configured for spraying. They offer the air-sealing, insulating, and broadcast spraying benefits of two-component foams without other additional equipment, mixing issues, and extra cost. They are particularly useful alone or combined with batt insulation as a cost-effective hybrid solution that optimizes both air-sealing and thermal insulating (R-Value).

In some embodiments, the one-component polyurethane foam compositions in accordance with the present disclosure include a combination of halogenated components, particularly brominated and chlorinated compounds, and phosphate components that are flame retardant whether they are isocyanate reactive or non-reactive. This unique combination of components greatly improves burn characteristics of cured polyurethane foam. ASTM E84 Class I or Class II fire resistance for full cavity-fill applications is not possible without this proper combination of suitable halogenated components and phosphate components that are effective flame retardants.

Generally, non-flammability, fire resistance, and flame retardancy may be tested according to any suitable method known in the art. In some embodiments, fire testing is commonly performed according to the ASTM E84 fire test. Other suitable testing methods include UL-94 and NFPA 286, NFPA 285 or similar standard tests, for example, those tests in EN 13823, BS 476 or ISO 11925, SBI, etc.

As used herein, fire-resistant means that the material is combustible but is capable of controlling fire spread and smoke development. Materials rated as Class I Fire-resistant materials are capable of passing the ASTM E84 fire test at claimed foam material thickness with Flame Spread Index of 25 or less and Smoke Development of 450 or less. Materials rated as Class II Fire-resistant materials are capable of passing the ASTM E84 fire test at claimed foam material thickness with Flame Spread Index of 75 or less and Smoke Development of 450 or less.

### Composition

In many embodiments, a one-component polyurethane spray foam composition according to the present disclosure comprises: a polyol; a compound containing one or more isocyanate functional groups; a propellant; a flame retardant; optionally a surfactant; and optionally a catalyst.

In many embodiments, a one-component polyurethane spray foam composition according to the present disclosure comprises: a halogenated polyurethane prepolymer; a propellant; a flame retardant; optionally a surfactant; and optionally a catalyst.

In some embodiments, a one-component polyurethane spray foam composition according to the present disclosure comprises: a non-halogenated polyurethane prepolymer, a polyurethane prepolymer, a propellant; and a flame retardant.

In some embodiments, the one-component polyurethane spray foam composition is fire-resistant. In some embodiments, the one-component polyurethane spray foam composition has increased fire resistance relative to conventional one-component polyurethane spray foam compositions. In some embodiments, the one-component polyurethane spray foam composition has an ASTM E84 Class I or Class II fire rating.

Generally, the one-component polyurethane spray foam composition according to the present disclosure is contained in an uncured form and then cures after application. In some embodiments, a cured composition is producible from the one-component polyurethane spray foam composition. In some embodiments, the one-component polyurethane spray foam composition is configured to cure. In some embodiments, the one-component polyurethane spray foam composition is configured to cure after spraying.

In some embodiments, the cured one-component polyurethane spray foam composition is a fire-resistant product. In some embodiments, the fire-resistant product is selected from the group consisting of fire-resistant adhesives, fire-resistant sealants, fire-resistant insulating materials, fire-resistant building materials, and combinations thereof.

Generally, the thermal insulation property is measured with ASTM or other standards. The term R-value (also denoted as RSI-value) is a measurement of thermal resistance per unit area and unit thickness. In some embodiments, the cured one-component polyurethane spray foam composition has an R-value of at least 3.5 per inch. In some embodiments, the cured one-component polyurethane spray foam composition has an R-value of at least 4 per inch. In some embodiments, the cured one-component polyurethane spray foam composition has an R-value of at least 4.5 per inch. In some embodiments, the cured one-component polyurethane spray foam composition has an R-value of at least 5 per inch. In some embodiments, the cured one-component polyurethane spray foam composition has an R-value of at least 5.5 per inch. In some embodiments, the cured one-component polyurethane spray foam composition has an R-value of at least 6 per inch. In some embodiments, the cured one-component polyurethane spray foam composition has an R-value of at least 6.5 per inch. In some embodiments, the cured one-component polyurethane spray foam composition has an R-value of at least 7 per inch.

Generally, cured foam density is a critical property of foam. Density may be measured in pounds per cubic foot (pcf). In some embodiments, the cured one-component polyurethane spray foam composition has a density in a range of from about 1 pcf to about 2 pcf. In some embodiments, the cured one-component polyurethane spray foam composition has a density in a range of from about 1.2 pcf to about 1.7 pcf. In some embodiments, the cured one-component polyurethane spray foam composition has a density in a range of from about 1.25 pcf to about 1.55 pcf.

Generally, the closed cell content is a critical property of foam. It is commonly calculated from open cell content which determined according to ASTM D6226 standard. In some embodiments, the cured one-component polyurethane spray foam composition has a closed-cell percentage of at least 30%, at least 35%, at least 40%, at least 45%, least 50%, at least 55%, at least 60%, at least 65%, at least 70%, at least 75%, at least 80%, at least 85%, at least 90%, at least 95%, or higher than 95%. In some embodiments, the cured one-component polyurethane spray foam composition has a closed-cell percentage in a range of from about 50% to about 95%. In some embodiments, the cured one-component polyurethane spray foam composition has a closed-cell percentage in a range of from about 70% to about 95%. In some embodiments, the cured one-component polyurethane spray foam composition has a closed-cell percentage in a range of from about 80% to about 90%.

In many embodiments, the one-component polyurethane spray foam composition comprises a polyol. In some embodiments, the polyol is selected from the group consisting of halogenated polyols, fire-resistant (FR) polyols, halogenated aliphatic polyether polyols, halogenated aromatic polyether polyols, phosphorus polyols, and combinations thereof. In some embodiments, the polyol comprises a fire-resistant (FR) polyol. In some embodiments, the polyol comprises a halogenated aliphatic polyether polyol. In some embodiments, the polyol comprises a halogenated aromatic polyether polyol. In some embodiments, the polyol comprises a mixture of a halogenated aliphatic polyether polyol and a halogenated aromatic polyether polyol. In some embodiments, the polyol comprises a phosphorus polyol. In some embodiments, the polyol comprises a phosphorus polyether polyol or a halogenated phosphorus polyether polyol.

In some embodiments, the fire-resistant (FR) polyol is selected from the group consisting of brominated polyols and phosphorus polyols.

In some embodiments, the polyols are selected from the group consisting of chlorinated polyols, brominated polyols, chlorinated and brominated polyols, and combinations thereof.

Generally, the polyol may possess any useful isocyanate-reactive functionality known in the art. In some embodiments, the polyol comprises a functionality in a range of from about 1.5 to about 4, preferably about 1.7 to about 3.2, and more preferably about 2 to about 2.5. In some embodiments, the polyol comprises 2 to 3 functional OH groups.

Generally, the polyol may possess any useful molecular weight known in the art. In some embodiments, the polyol comprises an average molecular weight in a range of from about 60 to about 6000 g/mol, preferably 150 to about 2000 g/mol, more preferably about 250 to about 1500 g/mol, and even more preferably about 300 to about 800 g/mol. In some embodiments, the polyol comprises an average molecular weight in a range of from about 200 to 2000 g/mol.

Generally, the polyol may possess any useful weight content of halogens known in the art. In some embodiments, the polyol comprises a weight content of halogens of 20 to 60% by weight.

In some preferred embodiments, the polyol has 2 functional OH groups, an average molecular weight of about 500 g/mol and a halogen content of about 40% by weight.

In some embodiments, the one-component polyurethane spray foam composition comprises a further polyol selected from the group consisting of polyether polyols, polyester polyols, aromatic polyols, aliphatic polyols, and combinations thereof.

In some embodiments, the compound containing one or more isocyanate functional groups is selected from the group consisting of polymeric isocyanates, aromatic isocyanates, aliphatic isocyanates, and combinations thereof. In some embodiments, the compound containing one or more isocyanate functional groups comprises an isocyanate (e.g. NCO). In some embodiments, the compound containing two or more isocyanate functional groups comprises a number of functional groups in a range of from about 2 to 3.2, preferably about 2 to about 2.7.

In some embodiments, the one-component polyurethane spray foam composition comprises a halogenated prepolymer that is a reaction product of a halogenated polyol and a compound containing one or more isocyanate functional groups. In other words, the isocyanate and polyols react to become a reaction product known in the art as a polyurethane prepolymer. In some embodiments, the prepolymer comprises a halogen content in a range of from about 5% to about 15% by weight.

In some embodiments, the one-component polyurethane spray foam composition comprises a phosphorus prepolymer that is a reaction product of a phosphorus polyol and a compound containing one or more isocyanate functional groups. In other words, the isocyanate and polyols react to become a reaction product known in the art as a polyurethane prepolymer. In some embodiments, the prepolymer comprises a phosphorus content in a range of from about 5% to about 15% by weight.

In some embodiments, the propellant comprises a flammable propellant selected from the group consisting of hydrocarbons, low molecular weight ether compounds, and combinations thereof. This type of propellant may be used for small container size and small application job or in an area with adequate ventilation. Although the propellant is flammable, the fully cured one-component foam can be fire-resistant, depending on the formulation and curing conditions. In some embodiments, the propellant comprises a flammable propellant selected from the group consisting of propane, butane, dimethyl ether (DME), hydrofluorocarbons, HFC-152a, hydrofluoroolefins, and combinations thereof. In some embodiments, the propellant comprises a mixture of propane, butane, and DME.

In some embodiments, the propellant comprises a non-flammable propellant selected from the group consisting of hydrofluoroolefins (HFO), hydrofluorocarbons (HFC), chlorocarbons, nitrogen gas, non-flammable gases, and combinations thereof. This type of propellant contributes to the non-flammability and global warming potential (GWP) status of the formulations. In some embodiments, the propellant comprises a hydrofluoroolefin selected from the group consisting of HFO 1234ze, HFO 1233zd, and combinations thereof. In some embodiments, the propellant comprises only non-flammable propellants.

In many embodiments, the one-component polyurethane spray foam composition may include suitable additional flame retardants known in the art. Suitable flame retardants may be reactive flame retardants or nonreactive flame retardants. In some embodiments, the flame retardant is selected from the group consisting of halogenated organophosphates, organophosphates, chlorinated paraffins, expandable graphite, phosphorus-based compounds, halogenated compounds, brominated compounds, and combinations thereof. In some embodiments, the flame retardant comprises tri-chloroethyl-phosphate (TCPP) and/or chlorinated paraffin.

In some embodiments, the flame retardant comprises expandable graphite. Expandible graphite is non-reactive and functions by expanding and forming a graphite char layer in the presence of high temperatures. In some embodiments, the expandable graphite has a particle size in a range of from 50 μm to about 400 μm. In some embodiments, the expandable graphite has a particle size in a range of from 90 μm to about 350 μm. In some embodiments, the expandable graphite is present in an amount of from about 2 wt % to about 30 wt %. In some embodiments, the expandable graphite is present in an amount of from about 3 wt % to about 20 wt %. In some embodiments, the expandable graphite is present in an amount of from about 4 wt % to about 15 wt %. In some embodiments, the expandable graphite is present in an amount of from about 5 wt % to about 10 wt %.

In many embodiments, the one-component polyurethane spray foam composition may include any suitable foam stabilizer or surfactant known in the art. In some embodiments, the foam stabilizer or surfactant comprises a silicone containing compound or a non-silicone containing compound. In some embodiments, the foam stabilizer or surfactant comprises a silicone containing compound.

In many embodiments, the one-component polyurethane spray foam composition may include any suitable catalyst known in the art. In some embodiments, the one-component polyurethane spray foam composition comprises an amine catalyst. In some embodiments, the one-component polyurethane spray foam composition comprises a catalyst selected from the group consisting of 2,2′-dimorpholinodiethylether (DMDEE or DMDLC), a stabilized DMDEE (DMDLS), and combinations thereof.

### Methods of Preparation

In many embodiments, the one-component polyurethane spray foam composition may be prepared according to any suitable method known in the art.

In some embodiments, the one-component polyurethane spray foam composition is prepared by forming a mixture comprising the components of the one-component polyurethane spray foam composition.

In some embodiments, the polyols, flame retardant, surfactant, catalyst, and optional other ingredients are mixed together in a mixing vessel to form a pre-blend. This pre-blend is further mixed with isocyanates and propellant or other additives, such as color, in a pressure rated container to allow reaction and form a mixture containing polyurethane prepolymer. The method or sequence can vary depending on equipment that is used. The filled container can be packaged with labels, spray nozzle and other accessories before being provided to applicator or sprayers.

### Methods of Use

In many embodiments, the one-component polyurethane spray foam composition may be used according to any suitable method known in the art.

In some embodiments, a method of using the one-component polyurethane spray foam composition comprises applying the one-component polyurethane spray foam composition to an application site.

In some embodiments, the applying the one-component polyurethane spray foam composition comprises dispensing the one-component polyurethane spray foam composition from a reservoir of a pressurized container. In some embodiments, the applying the one-component polyurethane spray foam composition comprises spraying the one-component polyurethane spray foam composition from a reservoir of a pressurized container in a wide broadcast pattern. A wide broadcast spray pattern evenly distributes sprayed material to a cavity of a substrate.

In some embodiments, the wide broadcast spray pattern has a width of at least 1, 2, 3, 4, 5, 6, 7, 8, or more inches when sprayed on a substrate. In some embodiments, the wide broadcast spray pattern has a width in a range of from about 3 inches to about 9 inches when sprayed on a substrate. In some embodiments, the wide broadcast spray pattern has a width of about 7.5 inches when sprayed on a substrate.

In some embodiments, the wide broadcast spray pattern has a width of at least 8 inches when sprayed on a substrate. In some embodiments, the wide broadcast spray pattern has a width of at least 6 inches when sprayed on a substrate. In some embodiments, the wide broadcast spray pattern has a width of at least 4 inches when sprayed on a substrate. In some embodiments, the wide broadcast spray pattern has a width of at least 3 inches when sprayed on a substrate.

In some embodiments, the application site comprises a surface optionally comprising a cavity and/or a hole. As used herein, “a surface optionally comprising a cavity and/or a hole” generally refers to an application site that may include small holes, cavities, and/or indentations as part of the application site.

In some embodiments, the application site is selected from the group consisting of a wall, a floor, a ceiling, a door, a window, a construction material, a rim joist, a band joist, an HVAC duct, an HVAC sealing, an application site in a basement, an application site in an attic, a hard-to-reach area, an insulation surface, cavities thereof, holes thereof, and combinations thereof.

In some embodiments, the application site has a temperature in the range of from about 20° F. to about 120° F., preferably about 30° F. to about 120° F., more preferably about 40° F. to about 100° F., and even more preferably about 55° F. to about 95° F.

### Dispenser

Generally, the one-component polyurethane spray foam composition may be dispensed with any suitable dispenser known in the art. However, conventional one-component polyurethane spray foam dispensers include straight, slender flow paths that dispense polyurethane foams in a bead shape. They do not provide for break-up of the foam and dispersion into a uniform thickness broadcast spray pattern. In other words, most dispensers known in the art are unsuitable for dispensing the one-component polyurethane spray foam composition according to the present disclosure. Rather, these conventional one-component polyurethane spray foam dispensers can only be used for applying foam in the form of a bead or very narrow band.

In many embodiments, the dispenser comprises a pressurized container and a mechanical applicator. In some embodiments, the pressurized container and the mechanical applicator are separable. In some embodiments, the mechanical applicator is attached to a side of the pressurized container for transportation and/or storage.

In some embodiments, the dispenser is configured to spray the one-component polyurethane spray foam composition in a wide broadcast pattern.

In some embodiments, the dispenser comprises a pressurized container comprising: a reservoir comprising a one-component polyurethane spray foam composition; and a valve assembly; and a mechanical applicator comprising: a valve connection fluidically connected to the valve assembly of the pressurized container; an outlet nozzle fluidically connected to the valve connection; and a fan spray outlet comprising a cat-eye-shaped aperture, wherein the fan spray outlet is fluidically connected to the outlet nozzle.

### Container

Generally, the one-component polyurethane spray foam composition may be stored, transported, and used in any suitable container known in the art. In many embodiments, the one-component polyurethane spray foam composition is contained in a pressurized container comprising a reservoir.

In some embodiments, the pressurized container is an aerosol can or canister. In many embodiments, the pressurized container is configured to be operated with one hand.

As used herein, an aerosol can is a relatively small container that is configured to be operated with one hand. In some embodiments, the aerosol can comprises a stem valve that is opened to release foam.

As used herein, a canister is a relatively large container that is configured to be operated with one or two hands. The dispensing from the canister may be achieved with a first hand while the canister is held with a second hand. In some embodiments, the canister has a stem valve on the canister that is opened to release foam, and a valve in an applicator that is used to meter and adjust the flow rate. In this embodiment, the canister includes two valves in series.

In some embodiments, the pressurized container comprises a reservoir and a valve assembly. The valve assembly is adjustable between a closed configuration and an open configuration. When in the closed configuration, the valve is non-depressed, and polyurethane foam cannot flow out of the reservoir. When in the open configuration, the valve is depressed or actuated, and polyurethane foam can flow out of the reservoir.

In some embodiments, the pressurized container comprises a reservoir and a ball valve assembly. The ball valve assembly is adjustable between a closed configuration and an open configuration. When in the closed configuration, the ball valve prevents flow of the polyurethane foam. When in the open configuration, the ball valve does not prevent flow of the polyurethane foam.

The pressurized container may be any suitable size known in the art. In some embodiments, the pressurized container is a size in a range of from about less than 5 oz to about more than 55 lbs. In some embodiments, the pressurized container is a size in a range of from about less than 9 oz to about more than 24 oz. In some embodiments, the pressurized container is a 10 oz, 12 oz, or 24 oz aerosol can. In some embodiments, the pressurized container is a size in a range of from about less than 10 lbs. to about more than 45 lbs. In some embodiments, the pressurized container is a 23 lb. canister.

In some embodiments, the pressurized container is reusable. In some embodiments, the pressurized container is reusable for up to 90 days, typically 30-45 days, after the first-time use.

In some embodiments, the pressurized container is configured to spray the one-component polyurethane spray foam composition at an application distance of up to about 36 inches. In some embodiments, the pressurized container is configured to spray the one-component polyurethane spray foam composition at an application distance in a range of from about 24 inches to about 36 inches. In some embodiments, the pressurized container is configured to spray the one-component polyurethane spray foam composition at an application distance in a range of from about 6 inches to about to about 15 inches.

### Mechanical Applicator

In many embodiments, the pressurized container comprises a mechanical applicator that is used to spray the one-component polyurethane spray foam composition in a wide broadcast pattern. In some embodiments, the combination of the fire-resistant one-component polyurethane foam composition and the mechanical applicator enables spraying the one-component polyurethane spray foam composition in a wide broadcast pattern.

Generally, the mechanical applicator comprises a valve connection to a valve assembly of the pressurized container, an outlet nozzle, and a fan spray outlet. The mechanical applicator is in fluidic communication with the container to enable flow of polyurethane foam from the container, through an internal flow path of the nozzle, and to the fan spray outlet. The mechanical applicator serves as a fluidic path from the outlet of the reservoir to the application site.

In some embodiments, the mechanical applicator comprises a fan spray outlet comprising a cat-eye-shaped aperture. The cat-eye-shaped aperture may be present in a variety of orientations, including horizontally, vertically, and angles therebetween. The cat-eye-shaped aperture may be present in a variety of different sizes.

In some embodiments, the cat-eye-shaped aperture has a major dimension in a range of from about 0.2 inches to about 0.5 inches. In some embodiments, the cat-eye-shaped aperture has a major dimension in a range of from about 0.23 inches to about 0.42 inches.

In some embodiments, the cat-eye-shaped aperture has a minor dimension in a range of from about 0.03 inches to about 0.09 inches. In some embodiments, the cat-eye-shaped aperture has a minor dimension in a range of from about 0.05 inches to about 0.075 inches.

In many embodiments, the fan spray outlet has a V-shaped notch on both sides of the cat-eye-shaped aperture. The V-shaped notch impacts the fan spray pattern height.

In some embodiments, the fan spray outlet further comprises a washer located fluidically upstream of the cat-eye-shaped aperture, wherein the washer is configured to disrupt and/or break up the one-component polyurethane spray foam composition. In these embodiments, the washer is in fluidic communication with the cat-eye-shaped aperture. In some embodiments, the washer is positioned about 4 to 7 mm from the cat-eye-shaped aperture. In some embodiments, the mechanical applicator comprises a fan spray outlet comprising an X-shaped washer. In some embodiments, the outlet nozzle is a monolithic piece and the X-shaped washer is located within a tip of the outlet nozzle. In some embodiments, the outlet nozzle is not a monolithic piece and the X-shaped washer is located outside a tip of the outlet nozzle.

In some embodiments, the washer comprises sharp points to enable mechanical breakup of the foam. In some embodiments, the washer comprises more than two sharp points. Two or fewer sharp points provides inadequate mechanical breakup of the foam. The sharp points may be symmetrically oriented or asymmetrically oriented. In some embodiments, the washer comprises three, four, five, six, seven, eight, nine, ten, or more than ten sharp points. In some embodiments, the washer comprises four sharp points.

In some embodiments, the mechanical applicator further comprises a trigger actuator. The trigger actuator engages the valve assembly of the pressurized container. In some embodiments, the trigger actuator is configured to actuate a valve of the pressurized container by tilting the valve. In some aerosol can embodiments, the trigger actuator is configured to actuate a valve of the pressurized container by tilting the valve.

In some embodiments, the trigger actuator is configured to actuate a ball valve of a hose connected to the pressurized container. In some canister formulations embodiments, the canister formulations, the trigger actuator is configured to actuate a ball valve of a hose connected to the pressurized container

In some embodiments, the trigger actuator comprises a hinge. In some embodiments, the trigger actuator comprises a living hinge. In some embodiments, the trigger actuator comprises a torsional member. In these embodiments, the living hinge and torsion member each fold and therefore provide benefits of reduced packaging dimensions, whereby, in a folded position, the mechanical applicator better fits on the side of the aerosol canister to save space in packaging.

Generally, the valve connection provides fluidic communication between an inner flow path of a nozzle assembly and a valve assembly of an aerosol canister. In some embodiments, the valve connection engages with the valve assembly of the pressurized container. In some embodiments, the valve connection tilts or depresses a valve of the pressurized container.

In many embodiments, the valve connection and the outlet nozzle are separable and joinable. Generally, the valve connection and the outlet nozzle may be joined with any suitable joining configuration known in the art. In some embodiments, the valve connection is joined to the outlet nozzle via a configuration selected from the group consisting of a ring snap fit and/or interference fit, a tongue and groove fit, threading, welding, adhesive, and combinations thereof.

In some embodiments, the valve connection comprises a ring snap fit and/or interference fit with the outlet nozzle.

In some embodiments, the valve connection comprises a threaded fit with the outlet nozzle.

In some embodiments, the valve connection comprises a nozzle assembly comprising a threading so that the outlet nozzle threads into a ball valve.

Specific embodiments of the mechanical applicator are depicted in the figures and described in detail below. These embodiments are non-limiting.

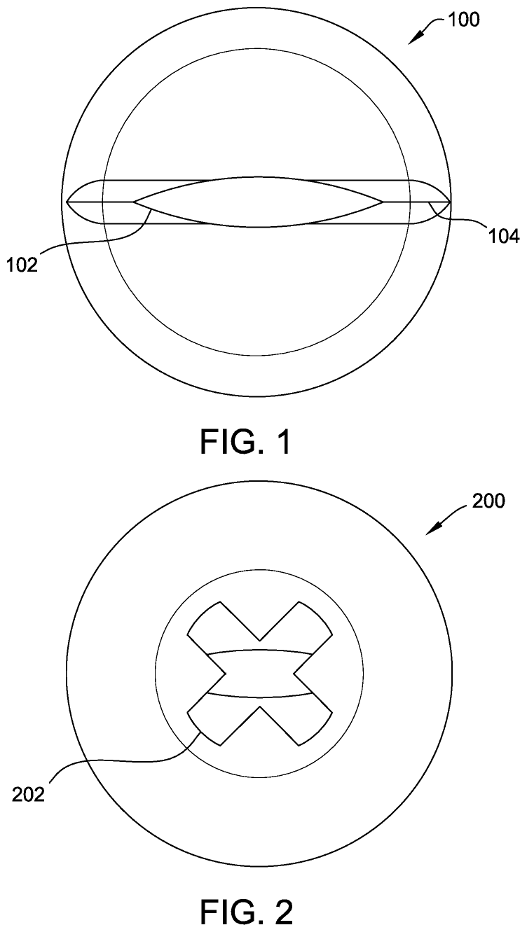

An embodiment of a fan spray outlet 100 is shown in FIG. 1. The fan spray outlet 100 has a cat-eye-shaped aperture 102 in the center. Although shown horizontally, the cat-eye-shaped aperture 102 may be oriented vertically. The cat-eye-shaped aperture 102 may be present in a variety of different sizes. The fan spray outlet 100 has a V-shaped notch 104 on both sides of the cat-eye-shaped aperture 102. The V-shaped notch 104 impacts the fan spray pattern height.

An embodiment of a washer 200 for configuration with the fan spray outlet 100 is shown in FIG. 2. The washer 200 has an X-shaped aperture 202 in the center. The washer 200 disrupts and/or breaks up foam before it passes through the fan spray outlet 100. As can be seen in FIG. 2, the washer 200 is positioned behind the fan spray outlet 100 such that the cat-eye-shaped aperture 102 is visible through the X-shaped aperture 202.

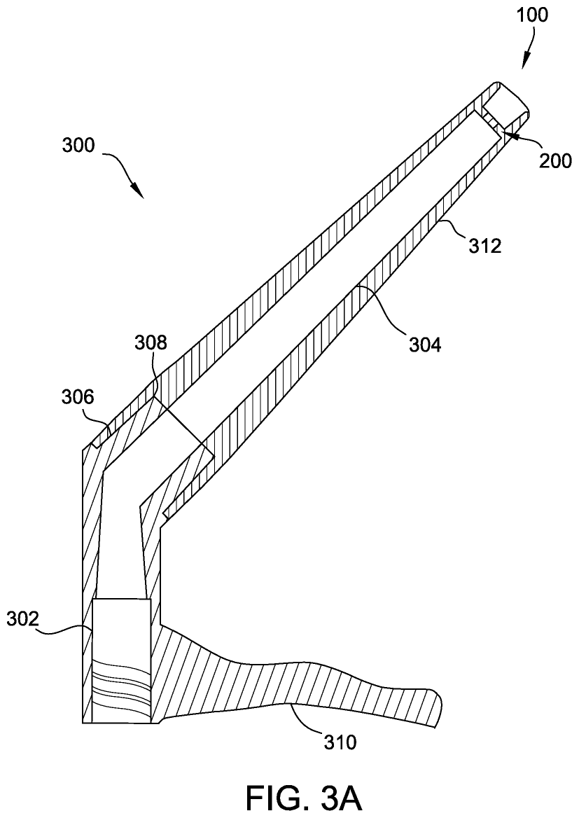

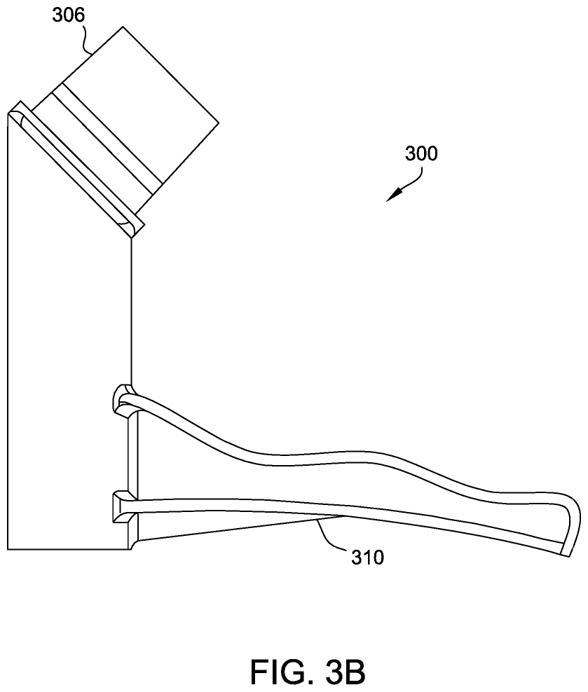

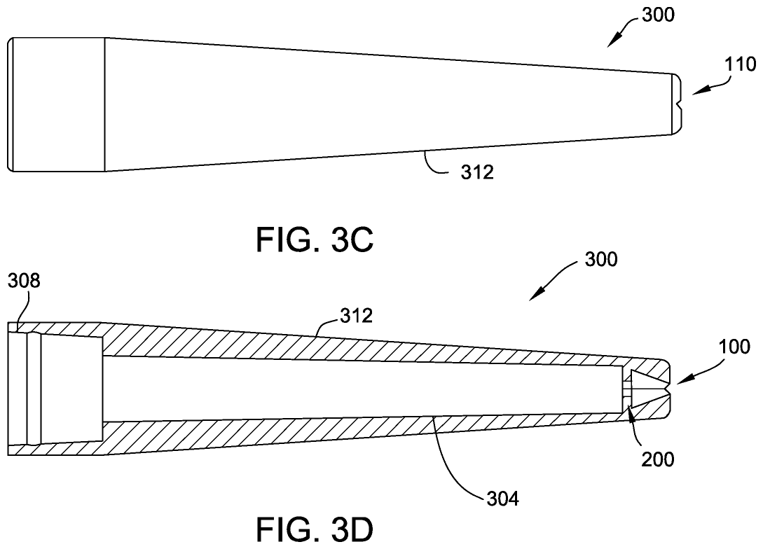

A nozzle assembly 300 configured to be used with an aerosol can is shown in FIG. 3A. The nozzle assembly 300 includes an outlet nozzle 312. This transparent view depicts the inner flow path 304 of the nozzle assembly 300. A valve connection 302 provides fluidic communication between the inner flow path 304 of the nozzle assembly 300 with the valve assembly of an aerosol canister (not shown). The inner flow path 304 is in fluidic communication with the washer 200, which in turn is in fluidic communication with the fan spray outlet 100. The nozzle assembly 300 includes a ring snap fit 306 for two-piece assembly. The nozzle assembly 300 also includes an interference fit 308 for sealing. The nozzle assembly 300 includes a trigger actuator 310 configured to actuate a valve of an aerosol canister (not shown) by tilting the valve.

A partial view of nozzle assembly 300 configured to be used with an aerosol can is shown in FIG. 3B. The nozzle assembly 300 includes a ring snap fit 306 for two-piece assembly. The nozzle assembly 300 includes a trigger actuator 310 configured to actuate a valve of an aerosol canister (not shown) by tilting the valve.

A partial view of nozzle assembly 300 configured to be used with an aerosol can is shown in FIG. 3C. This view depicts the exterior of the outlet nozzle 312. The fan spray outlet 100 is positioned at the end of the outlet nozzle.

A partial view of nozzle assembly 300 configured to be used with an aerosol can is shown in FIG. 3D. This view depicts the interior of the outlet nozzle 312. The fan spray outlet 100 is positioned at the end of the outlet nozzle 312. The inner flow path 304 is in fluidic communication with the washer 200, which in turn is in fluidic communication with the fan spray outlet 100. The nozzle assembly 300 also includes an interference fit 308 for sealing.

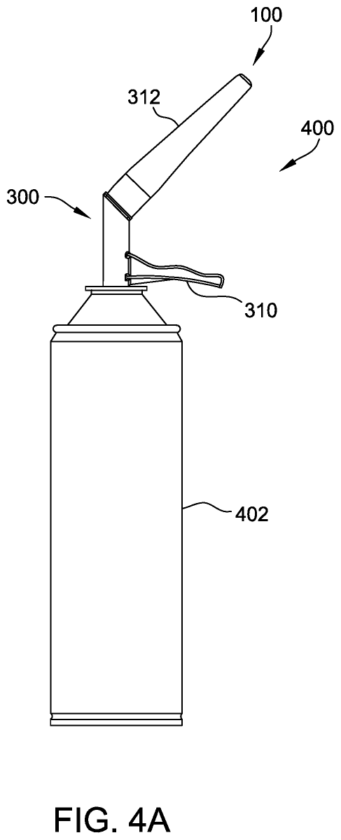

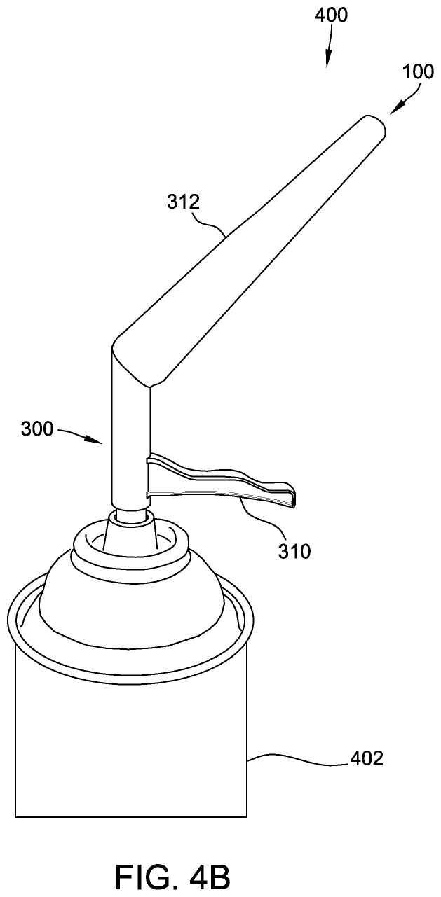

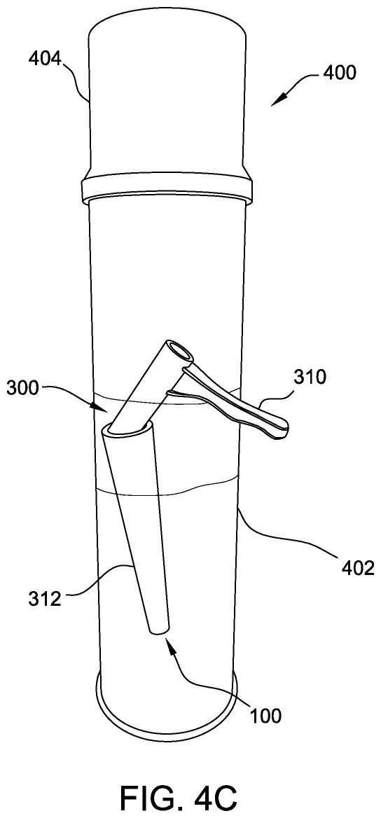

A combination 400 of an aerosol can 402 and nozzle assembly 300 is shown in FIG. 4A. The nozzle assembly 300 is connected to the aerosol can 402. The aerosol can 402 may include an internal dip tube (not shown).

A perspective view of a combination 400 of an aerosol can 402 and nozzle assembly 300 is shown in FIG. 4B. The nozzle assembly 300 is connected to the aerosol can 402. The aerosol can 402 may include an internal dip tube (not shown).

A perspective view of a combination 400 of an aerosol can 402 and nozzle assembly 300 is shown in FIG. 4C. The nozzle assembly 300 is taped to the side of the aerosol can 402 for transportation and/or storage. In this way, the nozzle assembly 300 is detachable from the aerosol can 402. The aerosol can 402 may include an internal dip tube (not shown). The aerosol can 402 also includes a cover 404 that goes over the top of the aerosol can 402.

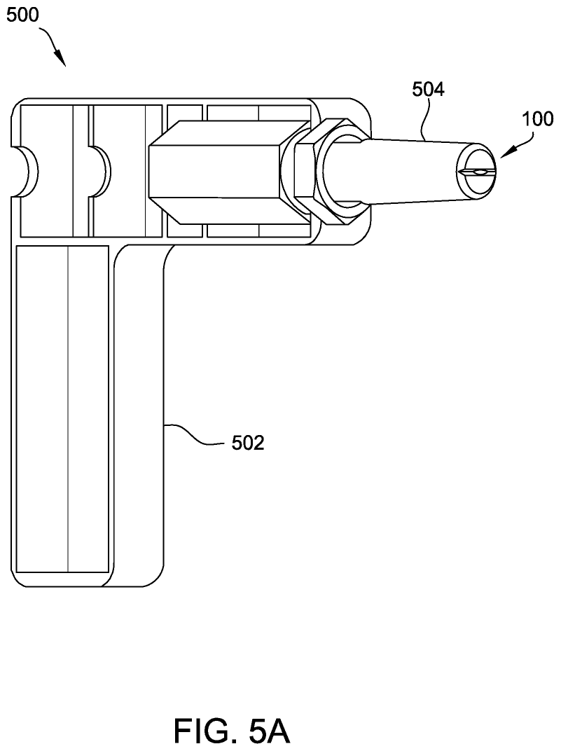

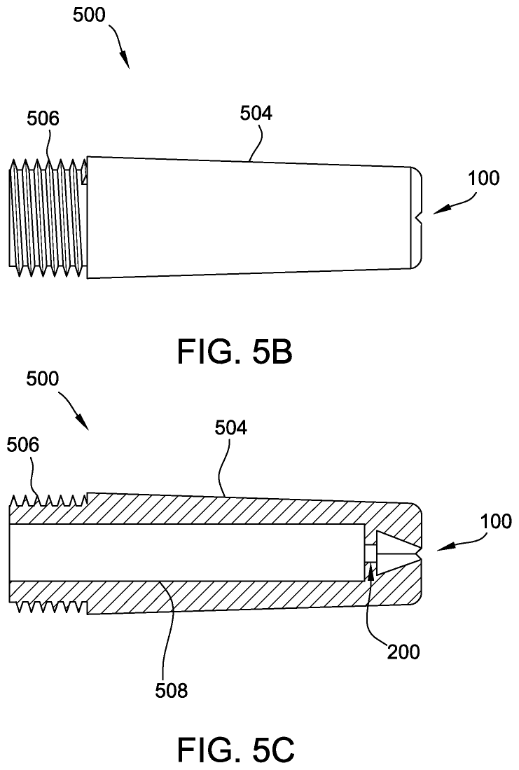

A nozzle assembly 500 configured to be used with a canister is shown in FIG. 5A. The nozzle assembly 500 includes an outlet nozzle 504. A fan spray outlet 100 is located at the end of the outlet nozzle 504. The nozzle assembly 500 includes a hollow handle 502. This hollow handle 502 makes one-handed application possible.

A partial view of nozzle assembly 500 configured to be used with a canister is shown in FIG. 5B. The nozzle assembly 500 includes a threading 506 so that the outlet nozzle 504 threads into a ball valve (not shown). A fan spray outlet 100 is located at the end of the outlet nozzle 504.

A partial view of nozzle assembly 500 configured to be used with a canister is shown in FIG. 5C. This view depicts the interior of the outlet nozzle 504. The fan spray outlet 100 is positioned at the end of the outlet nozzle 504. The inner flow path 508 is in fluidic communication with the washer 200, which in turn is in fluidic communication with the fan spray outlet 100. The nozzle assembly 500 includes a threading 506 so that the outlet nozzle 504 threads into a ball valve (not shown).

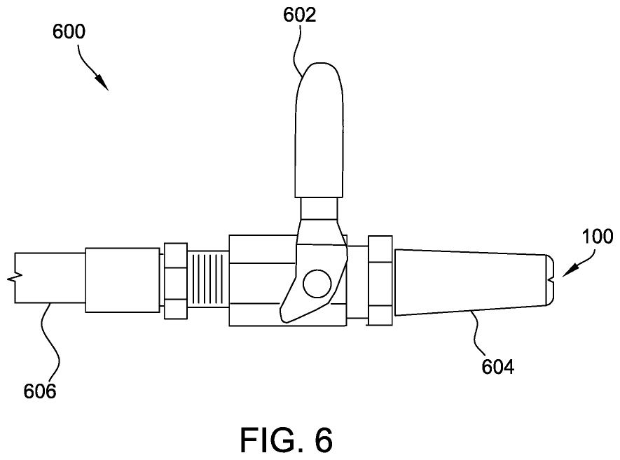

A side view of a nozzle assembly 600 configured to be used with a canister is shown in FIG. 6. The nozzle assembly 600 includes an outlet nozzle 604. A fan spray outlet 100 is located at the end of the outlet nozzle 604. The nozzle assembly 600 includes a rotatable handle 602. This rotatable handle 602 provides an ergonomic trigger and handle. The nozzle assembly 600 includes a fluidic line 606 in fluidic communication with a canister (not shown).

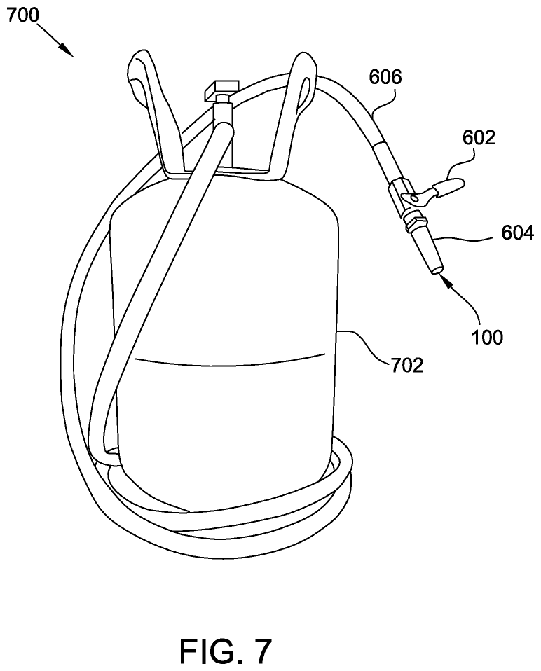

A perspective view of a combination 700 of a canister 702 and nozzle assembly 600 is shown in FIG. 7. The nozzle assembly 600 is connected to the aerosol can 702 through the fluidic line 606.

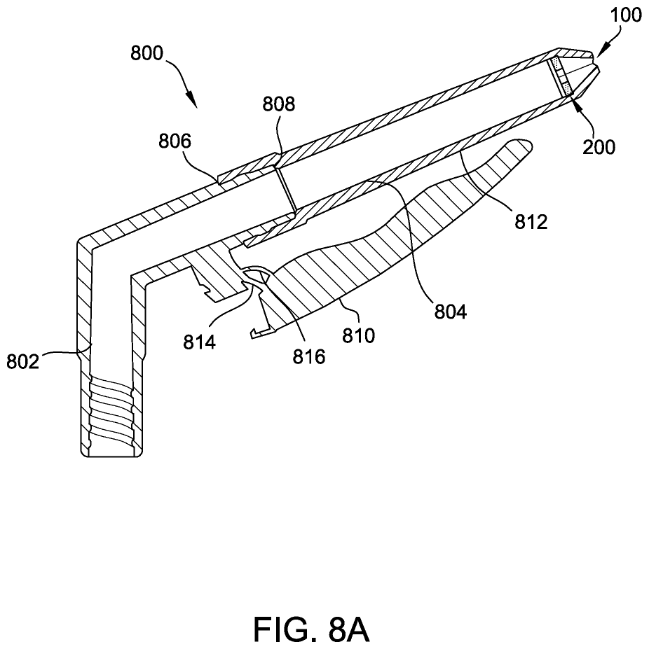

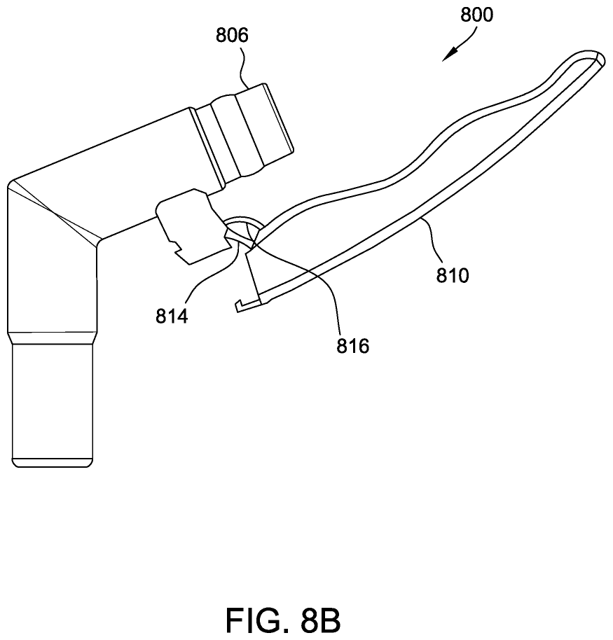

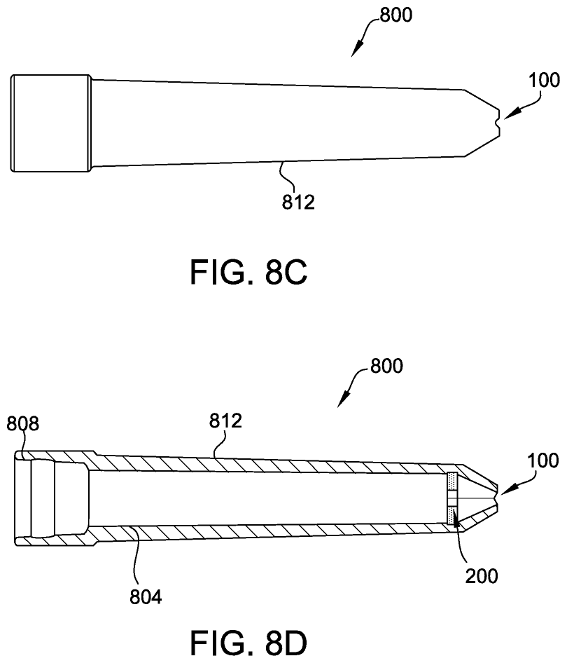

A nozzle assembly 800 configured to be used with an aerosol can is shown in FIG. 8A. The nozzle assembly 800 includes an outlet nozzle 812. This transparent view depicts the inner flow path 804 of the nozzle assembly 800. A valve connection 802 provides fluidic communication between the inner flow path 804 of the nozzle assembly 800 with the valve assembly of an aerosol canister (not shown). The inner flow path 804 is in fluidic communication with the washer 200, which in turn is in fluidic communication with the fan spray outlet 100. The nozzle assembly 800 includes a ring snap fit 806 for two-piece assembly. The nozzle assembly 800 also includes an interference fit 808 for sealing. The nozzle assembly 800 includes a trigger actuator 810 configured to actuate a valve of an aerosol canister (not shown) by tilting the valve. The trigger actuator 810 includes a living hinge 814 that includes a portion 816 that is configured to be breakable. When the portion 816 is broken, the trigger actuator 810 is able to be actuated.

A partial view of nozzle assembly 800 configured to be used with an aerosol can is shown in FIG. 8B. The nozzle assembly 800 includes a ring snap fit 806 for two-piece assembly. The nozzle assembly 800 includes a trigger actuator 810 configured to actuate a valve of an aerosol canister (not shown) by tilting the valve. The trigger actuator 810 includes a living hinge 814 that includes a portion 816 that is configured to be breakable. When the portion 816 is broken, the trigger actuator 810 is able to be actuated.

A partial view of nozzle assembly 800 configured to be used with an aerosol can is shown in FIG. 8C. This view depicts the exterior of the outlet nozzle 812. The fan spray outlet 100 is positioned at the end of the outlet nozzle.

A partial view of nozzle assembly 800 configured to be used with an aerosol can is shown in FIG. 8D. This view depicts the interior of the outlet nozzle 812. The fan spray outlet 100 is positioned at the end of the outlet nozzle 812. The inner flow path 804 is in fluidic communication with the washer 200, which in turn is in fluidic communication with the fan spray outlet 100. The nozzle assembly 800 also includes an interference fit 808 for sealing.

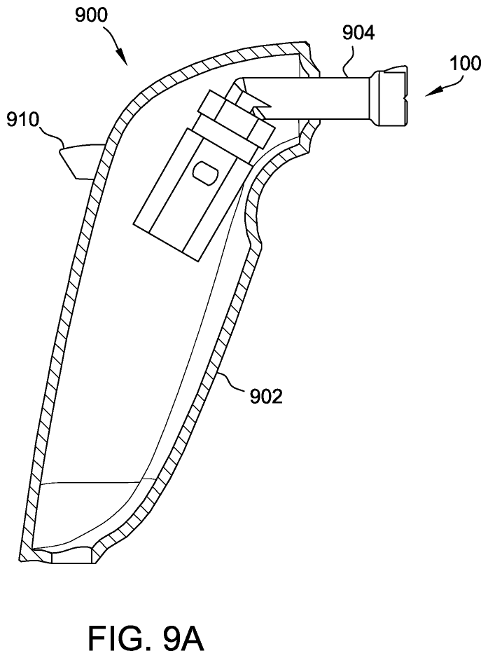

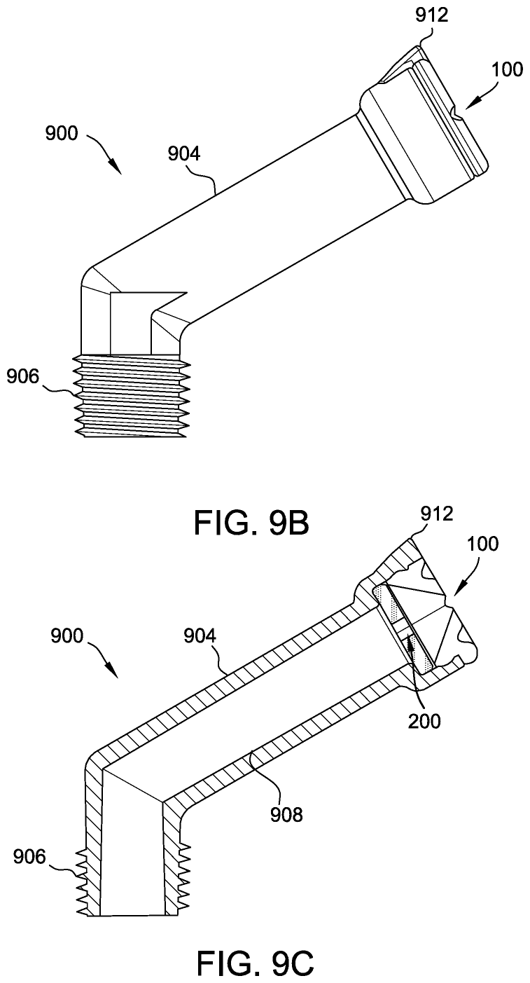

A nozzle assembly 900 configured to be used with a canister is shown in FIG. 9A. The nozzle assembly 900 includes an outlet nozzle 904. A fan spray outlet 100 is located at the end of the outlet nozzle 904. The nozzle assembly 900 includes a hollow handle 902. This hollow handle 902 makes one-handed application possible. Hollow handle 902 includes a thumb grip 910 that enables one-handed uses.

A partial view of nozzle assembly 900 configured to be used with a canister is shown in FIG. 9B. The nozzle assembly 900 includes a threading 906 so that the outlet nozzle 904 threads into a ball valve (not shown). A fan spray outlet 100 is located at the end of the outlet nozzle 904. The fan spray outlet 100 includes a tip 112 that serves as a clocking feature.

A partial view of nozzle assembly 900 configured to be used with a canister is shown in FIG. 9C. This view depicts the interior of the outlet nozzle 904. The fan spray outlet 100 is positioned at the end of the outlet nozzle 904. The inner flow path 908 is in fluidic communication with the washer 200, which in turn is in fluidic communication with the fan spray outlet 100. The nozzle assembly 900 includes a threading 906 so that the outlet nozzle 904 threads into a ball valve (not shown). The fan spray outlet 100 optionally includes a tip 912 that serves as a clocking feature.

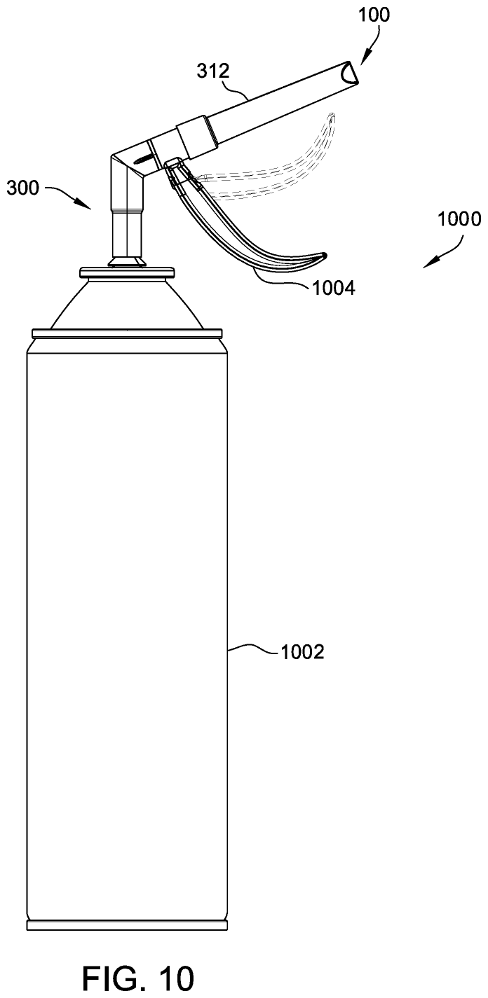

A combination 1000 of an aerosol can 1002 and nozzle assembly 300 is shown in FIG. 10. Fan spray outlet 100 includes tapering on the exterior surfaces and a vertically oriented aperture. The nozzle assembly 300 is connected to the aerosol can 1002. The aerosol can 1002 may include an internal dip tube (not shown). The nozzle assembly 300 includes a trigger actuator 1004 configured to actuate a valve of the aerosol can 1002 by tilting the valve (not shown). In this embodiment, trigger actuator 1004 includes a torsional member that folds between a folded position (dashed lines) and an unfolded position (solid lines).

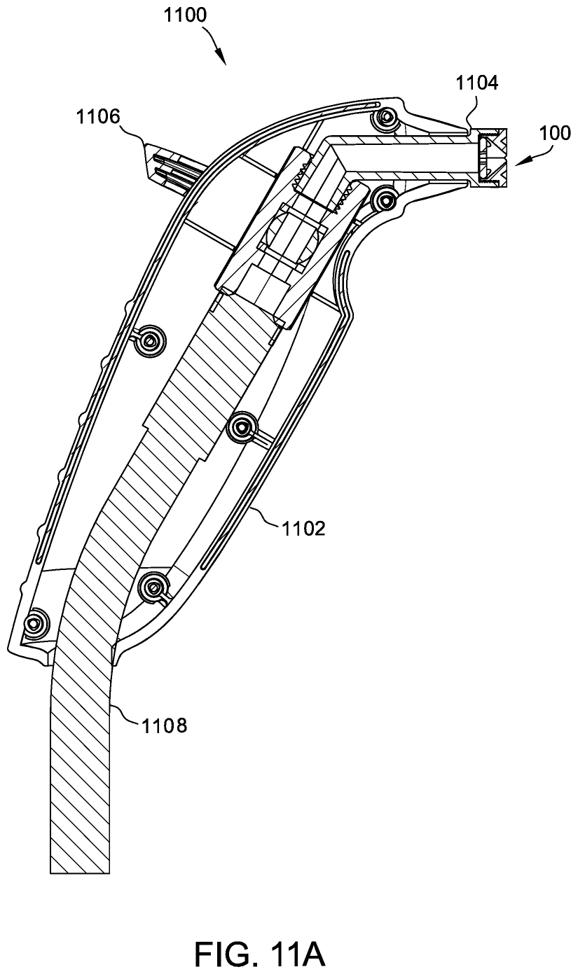

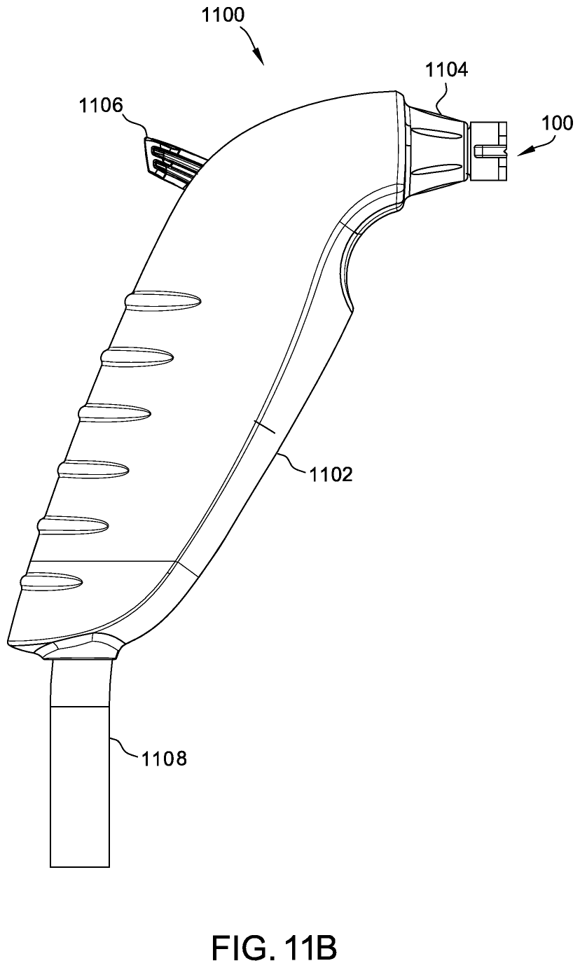

A nozzle assembly 1100 configured to be used with a canister is shown in FIGS. 11A and 11B. FIG. 11A depicts a cross-sectional view of the nozzle assembly 1100 and FIG. 11B depicts a side view of the nozzle assembly 1100. The nozzle assembly 1100 includes an outlet nozzle 1104. A fan spray outlet 100 is located at the end of the outlet nozzle 1104. The nozzle assembly 1100 includes a hollow handle 1102. This hollow handle 1102 makes one-handed application possible. Hollow handle 1102 includes a thumb grip 1106 that enables one-handed uses. The nozzle assembly 1100 is configured to be connected with a canister by a hose 1108.

Exemplary embodiments of this disclosure include, but are not limited to the following:

Embodiment 1. A one-component polyurethane spray foam composition comprising:
(a) a polyol;
(b) a compound containing one or more isocyanate functional groups;
(c) a propellant;
(d) a flame retardant;
(e) optionally a surfactant; and
(f) optionally a catalyst.

Embodiment 2. The one-component polyurethane spray foam composition of embodiment 1, wherein the polyol is fire-resistant.

Embodiment 3. The one-component polyurethane spray foam composition of embodiment 1, wherein the polyol comprises a halogenated aliphatic polyether polyol or a halogenated phosphorus aliphatic polyether polyol.

Embodiment 4. The one-component polyurethane spray foam composition of embodiment 1, further comprising a polyol selected from the group consisting of polyether polyols, polyester polyols, aromatic polyols, aliphatic polyols, and combinations thereof.

Embodiment 5. A cured composition producible from the one-component polyurethane spray foam composition of embodiment 1, wherein the cured composition has an ASTM E84 Class I fire rating.

Embodiment 6. A cured composition producible from the one-component polyurethane spray foam composition of embodiment 1, wherein the cured composition has an R-value of at least 4.

Embodiment 7. A cured composition producible from the one-component polyurethane spray foam composition of embodiment 1, wherein the cured composition has a closed-cell percentage of at least 80%.

Embodiment 8. The one-component polyurethane spray foam composition of embodiment 1, wherein the compound containing one or more isocyanate functional groups is selected from the group consisting of polymeric isocyanates, aromatic isocyanates, aliphatic isocyanates, and combinations thereof.

Embodiment 9. The one-component polyurethane spray foam composition of embodiment 1, wherein the propellant comprises a non-flammable propellant selected from the group consisting of hydrofluoroolefins, hydrofluorocarbons, and combinations thereof.

Embodiment 10. The one-component polyurethane spray foam composition of embodiment 1, wherein the propellant comprises a flammable propellant selected from the group consisting of hydrocarbons, ethers, hydrofluorocarbons, hydrofluorocarbon-152a, hydrofluoroolefins, and combinations thereof.

Embodiment 11. The one-component polyurethane spray foam composition of embodiment 1, wherein the flame retardant is selected from the group consisting of halogenated organophosphates, organophosphates, chlorinated paraffins, expandable graphite, phosphorus-based compounds, halogenated compounds, brominated compounds, and combinations thereof.

Embodiment 12. A dispenser comprising a pressurized container comprising a reservoir comprising the one-component polyurethane spray foam composition of embodiment 1.

Embodiment 13. The dispenser of embodiment 12, wherein the dispenser is configured to spray the one-component polyurethane spray foam composition in a wide broadcast pattern.

Embodiment 14. A fire-resistant product comprising a cured composition producible from the one-component polyurethane spray foam composition of embodiment 1, wherein the fire-resistant product is selected from the group consisting of fire-resistant adhesives, fire-resistant sealants, fire-resistant insulating materials, fire-resistant building materials, and combinations thereof.

Embodiment 15. A method of making a one-component polyurethane spray foam composition comprising:
(a) a polyol;
(b) a compound containing one or more isocyanate functional groups;
(c) a propellant;
(d) a flame retardant;
(e) optionally a surfactant; and
(f) optionally a catalyst, the method comprising forming a mixture comprising (a)-(f).

Embodiment 16. A method of using a one-component polyurethane spray foam composition comprising:
(a) A polyol;
(b) a compound containing one or more isocyanate functional groups;
(c) a propellant;
(d) a flame retardant;
(e) optionally a surfactant; and
(f) optionally a catalyst, the method comprising applying the one-component polyurethane spray foam composition to an application site.

Embodiment 17. The method of embodiment 16, wherein the applying the one-component polyurethane spray foam composition comprises dispensing the one-component polyurethane spray foam composition from a reservoir of a pressurized container.

Embodiment 18. The method of embodiment 16, wherein the applying the one-component polyurethane spray foam composition comprises spraying the one-component polyurethane spray foam composition from a reservoir of a pressurized container in a wide broadcast pattern.

Embodiment 19. The method of embodiment 16, wherein the application site comprises a surface, a cavity, and/or a hole.

Embodiment 20. The method of embodiment 16, wherein the application site has a temperature in the range of from 20° F. to 120° F.

Embodiment 21. A dispenser comprising:
a pressurized container comprising:
   a reservoir comprising a one-component polyurethane spray foam composition; and
   a valve assembly; and
a mechanical applicator comprising:
   a valve connection fluidically connected to the valve assembly of the pressurized container;
   an outlet nozzle fluidically connected to the valve connection; and
   a fan spray outlet comprising a cat-eye-shaped aperture, wherein the fan spray outlet is fluidically connected to the outlet nozzle.

Embodiment 22. The dispenser of embodiment 21, wherein the dispenser is configured to spray the one-component polyurethane spray foam composition in a wide broadcast pattern.

Embodiment 23. The dispenser of embodiment 21, wherein the mechanical applicator further comprises a trigger actuator.

Embodiment 24. The dispenser of embodiment 21, wherein the fan spray outlet further comprises a washer located fluidically upstream of the cat-eye-shaped aperture, wherein the washer is configured to disrupt and/or break up the one-component polyurethane spray foam composition.

Embodiment 25. The dispenser of embodiment 21, wherein a cured composition producible from the one-component polyurethane spray foam composition has an ASTM E84 Class I or Class II fire rating.

Embodiment 26. A method of using the dispenser of embodiment 21, the method comprising applying the one-component polyurethane spray foam composition to an application site.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever.

### Example 1. Comparison Between Known Formulations and Formulations in Accordance with the Present Disclosure

Non-limiting examples of one-component polyurethane spray foam compositions have been prepared. As seen in Table 1, the one-component polyurethane spray foam compositions in accordance with the present disclosure outperform conventional aerosol formulations, conventional canister formulations, and a comparative spray formulation known in the art at least by being configurable for a broadcast fan spray, including a non-flammable propellant, meeting a Class I fire test rating for building code requirements, and having a low GWP.

Traditional one-component polyurethane foam formulations include polyols (polyester/or polyether polyol with functionality of 2-3), a DMDEE catalyst, a foam stabilizer/surfactant, a flame retardant (typically TCPP), isocyanate (typically polymeric MDI), and a propellant/blowing agent. In aerosol can formulations (in sizes of 30.5 oz or less), flammable propellants are typically used (e.g. a blend of propane, isobutane and dimethyl ether). In canister formulations (in sizes of 10, 16, or 23 lbs.), non-flammable propellants are typically used (one of more of HFC 134a, HFO 1234ze, HFO 1233zd, etc.).

TABLE 1
Comparison between known formulations and inventive compositions in accordance
with the present disclosure. The values are shown as weight percentages.

| | | | Comparative | |
|---|---|---|---|---|
| | | | 1K Spray | |
| | Conventional | Conventional | Formulation | |
| | OCF Aerosol | OCF Canister | (U.S. Pat. No. | Inventive |
| Component | Formulation | Formulation | 10,815,353) | Compositions |
| Halogenated | N/A | N/A | N/A | 5-25 |
| Polyether Polyols | | | | |
| Polyether, polyester, | 5-18 | 5-18 | 5-18 | N/A |
| or combo diol | | | | |
| Polyether, polyester, | 3-10 | 3-10 | 3-10 | N/A |
| or combo triol | | | | |
| Tri-chloroethyl- | 5-30 | 5-30 | 5-14 | 5-30 |
| phosphate (TCPP) | | | | |
| Chlorinated Paraffin | 0-25 | 0-25 | N/A | 2.5-20 |
| Silicone stabilizer | 0.5-3 | 0.5-3 | 2.5-14 | 0.5-5 |
| (surfactant) | | | | |
| DMDLS or DMDEE | 0.5-3 | 0.5-3 | 0.5-3 | 0.5-3 |
| catalyst | | | | |
| Polymeric MDI | 30-55 | 30-55 | 37-49 | 30-55 |
| Propane/isobutane, | 5-20 | N/A | 10-22 | N/A |
| mixture | | | | |
| Dimethyl ether | 5-20 | N/A | 2-9 | N/A |
| (DME) | | | | |
| 1,1-difluroethane | N/A | 0-25 | 0-16 | N/A |
| (HFC 152) or other | | | | |
| propellant | | | | |
| 1,1,1,2- | N/A | 0-25 | N/A | N/A |
| Tetrafluoroethane | | | | |
| (HFC 134A) | | | | |
| HFO-1234ze | N/A | 0-25 | N/A | 9-30 |
| HFO-1233zd | N/A | N/A | N/A | 0-10 |
| Broadcast fan spray | No | No | Yes | Yes |
| Non-flammable | No | Yes | No | Yes |
| propellant | | | | |
| Cavity fill | No | No | No | Yes |
| application meeting | | | | |
| Building Codes | | | | |
| (Class I/II fire rated | | | | |
| @ full coverage | | | | |
| spray) | | | | |
| Low GWP | No | Maybe | Yes | Yes |
| propellant | | | | |

### Example 2. Inventive Compositions

Non-limiting examples of one-component polyurethane spray foam compositions have been prepared. As seen in Table 2 and Table 3, several inventive compositions in accordance with the present disclosure are configurable for a broadcast fan spray, include a non-flammable propellant, meet Building Code with Class I or Class II fire rating, and have a low GWP.

Compositions according to the present disclosure include a combination of halogenated components and phosphate components that are flame retardant. Such components include chlorinated paraffins and brominated compounds and phosphate compounds. This unique combination of components greatly improves burn characteristics of cured polyurethane foam. ASTM E84 class I fire resistance for full cavity-fill applications is not possible without this combination of halogenated components and phosphate components that are flame retardant.

The type of propellant contributes to the flammability and GWP status of the formulations. For example, HFO 1234ze, HFO 1233zd, HFO-1336mzz-Z, and HFO-1336mzz-E are the only commercially available non-flammable propellant or propellant blends that qualify as low GWP. As another example, Composition B includes a flammable propellant. However, it may be sprayed broadcast in a fan pattern. Once fully cured, the foam is capable of passing the ASTM E84 fire test (either Class I or Class II) and meeting other building code required properties.

TABLE 2
Embodiments of compositions in accordance with the present
disclosure. The values are shown as weight percentages.

| Component | Composition A | Composition B | Composition C |
|---|---|---|---|
| Halogenated | 5-25 | 5-25 | 5-25 |
| polyol(s) | | | |
| Tri-chloroethyl- | 5-30 | 5-30 | 5-30 |
| phosphate (TCPP) | | | |
| Chlorinated Paraffin | 0-25 | 0-25 | 0-25 |
| Silicone stabilizer | 0.5-5 | 0.5-5 | 0.5-5 |
| (surfactant) | | | |
| DMDLS or DMDEE | 0.5-3 | 0.5-3 | 0.5-3 |
| catalyst | | | |
| Polymeric MDI | 35-55 | 35-55 | 35-55 |
| Propane/isobutane, | N/A | 5-20 | N/A |
| combo | | | |
| dimethyl ether | N/A | 5-20 | N/A |
| (DME) | | | |
| 1,1,1,2- | N/A | N/A | 9-30 |
| Tetrafluoroethane | | | |
| (HFC 134A) | | | |
| HFO-1234ze | 9-30 | N/A | N/A |
| Broadcast fan spray | Yes | Yes | Yes |
| Non-flammable | Yes | No | Yes |
| propellant | | | |
| Cavity fill | Yes | Yes | Yes |
| application meeting | | | |
| Building Codes | | | |
| (Class I/II fire rated | | | |
| @ full coverage | | | |
| spray) | | | |
| Low GWP | Yes | Yes | No |
| propellant | | | |

TABLE 3
Embodiments of compositions in accordance with the present
disclosure. The values are shown as weight percentages.

| | Composition | Composition | Composition | Composition |
|---|---|---|---|---|
| Component | E | F | G | H |
| Halogenated | 5-25 | 2-10 | 2-5 | N/A |
| polyol(s) | | | | |
| Aromatic polyester | N/A | 5-30 | N/A | N/A |
| polyol | | | | |
| Aliphatic diol | N/A | N/A | 5-20 | 0-20 |
| polyether, | | | | |
| polyester, or | | | | |
| combo | | | | |
| Aliphatic triol | N/A | N/A | 5-20 | 0-20 |
| polyether, | | | | |
| polyester, or | | | | |
| combo | | | | |
| Tri-chloroethyl- | 5-30 | 5-35 | 5-35 | 5-30 |
| phosphate (TCPP) | | | | |
| Chlorinated | N/A | 0-25 | 0-25 | 2-20 |
| Paraffin | | | | |
| Silicone stabilizer | 0.5-5 | 0.5-5 | 0.5-5 | 0.5-5 |
| (surfactant) | | | | |
| DMDLS or | 0.5-3 | 0.5-3 | 0.5-3 | 0.5-3 |
| DMDEE catalyst | | | | |
| Polymeric MDI | 30-55 | 30-55 | 30-55 | 30-55 |
| HFO-1234ze | 9-30 | 9-30 | 9-30 | 9-30 |
| HFO-1233zd | 0-10 | 0-10 | 0-10 | 0-10 |
| Broadcast fan | Yes | Yes | Yes | Yes |
| spray | | | | |
| Non-flammable | Yes | Yes | Yes | Yes |
| propellant | | | | |
| Cavity fill | Yes | Maybe | No | No |
| application | | | | |
| meeting Building | | | | |
| Codes (Class I/II | | | | |
| fire rated @ full | | | | |
| coverage spray) | | | | |
| Low GWP | Yes | Yes | Yes | Yes |
| propellant | | | | |

### Example 3. Inventive Composition

The above formulations show each raw material being manufactured for OCF products. Once the manufacturing process is completed, the isocyanate and polyols react to become a reaction product known in the art as a polyurethane prepolymer. A particularly advantageous embodiment of a composition in accordance with the present disclosure is shown in Table 4. As seen in Table 4, the embodied inventive composition contains halogenated polyurethane prepolymer, propellant, and fire retardant. The composition is configurable for a broadcast fan spray and includes a non-flammable and low GWP propellant. The cured foam meets Class I fire rating and Building Codes.

The embodiment of this example passed the ASTM E84 class I test with fully-covered @ 2.75″ thick. Passing fully-covered testing is critical for cavity-fill applications in order to comply with building code requirements.

TABLE 4
Embodiment of a composition in accordance with the present
disclosure. The values are shown as weight percentages.

| Component | Composition I |
|---|---|
| Halogenated prepolymer containing 4 to 15% | 55.5 |
| halogen | |
| Mixture of TCPP and chlorinated paraffin | 22.7 |
| Foam stabilizer (Silicone surfactant) | 1.3 |
| DMDEE catalyst | 0.5 |
| Mixture of HFO-1234ze and HFO-1233zd | 20 |
| Broadcast fan spray | Yes |
| Non-flammable propellant | Yes |
| Cavity fill application meeting Building Codes | Yes |
| (Class I/II fire rated @ full coverage spray) | |
| Low GWP propellant | Yes |

The present disclosure demonstrates one-component polyurethane foam compositions with multiple beneficial properties. These foam compositions are suitable to be sprayed in broadcast pattern within a temperature range of about 40° F. to about 120° F. The cured foam has a density of about 1.25 to 1.55 pcf (pounds per cubic foot), an R-value of about 3.5-7, a closed cell value of at least 50%, and achieve a Class I fire rating in cavity fill applications according to ASTM E-84. The compositions of the present disclosure are useful in a wide variety of applications, and particularly useful in construction applications.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A one-component polyurethane spray foam composition comprising:
(a) a polyol;
(b) a compound containing one or more isocyanate functional groups;
(c) a propellant;
(d) a flame retardant;
(e) optionally a surfactant; and
(f) optionally a catalyst.

2. The one-component polyurethane spray foam composition of claim 1, wherein the polyol is fire-resistant.

3. The one-component polyurethane spray foam composition of claim 1, wherein the polyol comprises a halogenated polyether polyol or a phosphorus polyether polyol.

4. A cured composition producible from the one-component polyurethane spray foam composition of claim 1, wherein the cured composition has an ASTM E84 Class I or Class II fire rating.

5. A cured composition producible from the one-component polyurethane spray foam composition of claim 1, wherein the cured composition has an R-value of at least 3.5.

6. A cured composition producible from the one-component polyurethane spray foam composition of claim 1, wherein the cured composition has a closed-cell percentage of at least 50%.

7. The one-component polyurethane spray foam composition of claim 1, wherein the compound containing one or more isocyanate functional groups is selected from the group consisting of polymeric isocyanates, aromatic isocyanates, aliphatic isocyanates, and combinations thereof.

8. The one-component polyurethane spray foam composition of claim 1, wherein the propellant comprises a non-flammable propellant selected from the group consisting of hydrofluoroolefins, hydrofluorocarbons, and combinations thereof.

9. The one-component polyurethane spray foam composition of claim 1, wherein the propellant comprises a flammable propellant selected from the group consisting of hydrocarbons, ethers, hydrofluorocarbons, hydrofluorocarbon-152a, hydrofluoroolefins, and combinations thereof.

10. The one-component polyurethane spray foam composition of claim 1, wherein the flame retardant is selected from the group consisting of halogenated organophosphates, organophosphates, chlorinated paraffins, expandable graphite, phosphorus-based compounds, halogenated compounds, brominated compounds, and combinations thereof.

11. A fire-resistant product comprising a cured composition producible from the one-component polyurethane spray foam composition of claim 1, wherein the fire-resistant product is selected from the group consisting of fire-resistant adhesives, fire-resistant sealants, fire-resistant insulating materials, fire-resistant building materials, and combinations thereof.

12. A method of using the one-component polyurethane spray foam composition of claim 1, the method comprising applying the one-component polyurethane spray foam composition to an application site.

13. The method of claim 12, wherein the application site comprises a surface, a cavity, and/or a hole.

14. The method of claim 12, wherein the application site has a temperature in the range of from 20° F. to 120° F.

15. A method of making a one-component polyurethane spray foam composition comprising:
(a) a polyol;
(b) a compound containing one or more isocyanate functional groups;
(c) a propellant;
(d) a flame retardant;
(e) optionally a surfactant; and
(f) optionally a catalyst,
the method comprising forming a mixture comprising (a)-(f).

16. A dispenser comprising:
a pressurized container comprising:
a reservoir comprising a one-component polyurethane spray foam composition; and
a valve assembly; and
a mechanical applicator comprising:
a valve connection fluidically connected to the valve assembly of the pressurized container;
an outlet nozzle fluidically connected to the valve connection; and
a fan spray outlet comprising a cat-eye-shaped aperture, wherein the fan spray outlet is fluidically connected to the outlet nozzle.

17. The dispenser of claim 16, wherein the dispenser is configured to spray the one-component polyurethane spray foam composition in a wide broadcast pattern.

18. The dispenser of claim 16, wherein the mechanical applicator further comprises a trigger actuator.

19. The dispenser of claim 16, wherein the fan spray outlet further comprises a washer located fluidically upstream of the cat-eye-shaped aperture, wherein the washer is configured to disrupt and/or break up the one-component polyurethane spray foam composition.

20. The dispenser of claim 16, wherein a cured composition producible from the one-component polyurethane spray foam composition has an ASTM E84 Class I or Class II fire rating
